(19) United States
(12) Patent Application Publication
(10) Pub. No.: US 2006/0012348 A1
(43) Pub. Date: Jan. 19, 2006

(54) Coupled inductor DC/DC converter

(76) Inventors: Qun Zhao, Blacksbrug, VA (US); Fred C. Lee, Blacksburg, VA (US); Peng Xu, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 09/843,143

(22) Filed: Apr. 27, 2001

Related U.S. Application Data
(60) Provisional application No. 60/200,003, filed on Apr. 27, 2000.
(60) Provisional application No. 60/231,556, filed on Sep. 11, 2000.

(51) Int. Cl. G05F 1/24

(52) U.S. Cl. 323/259

(57) ABSTRACT

DC/DC converter for managing high voltage gain that includes an input side having a high tap and a low tap, an output side having a high tap and a low tap, a converter circuit interconnecting the input side and the output side, and a steering branch having at least one rectifier and one of at least one winding and a capacitor. The steering branch interconnects the input side with the output side. The converter circuit is preferably selected from the following types of conventional converter circuits: buck, boost, buck-boost, Cuk, Sepic, Zeta, half bridge boost for low-line input, half bridge boost for high-line input, and half bridge boost for universal-line input. The DC/DC converter uses coupled inductor to shift the original rectifier current to an added branch and then control the rectifier current decrease rate in the new branch when rectifier turns off.

### CROSS-REFERENCE TO RELATED APPLICATIONS

This application claims priority to U.S. Provisional Application Ser. No. 60/200,003, filed on Apr. 27, 2000, and Ser. No. 60/231,556, filed on Sep. 11, 2000.

### DESCRIPTION

### BACKGROUND OF THE INVENTION

1. Field of the Invention

The present invention generally relates to DC to DC converters and, more particularly, to DC to DC coupled inductor converters.

2. Background Description

Continuous current mode (CCM) boost converters are widely used as front-end converters for active input current shaping. The output voltage of these kinds of front end converters for power factor correction (PFC) is generally higher than 375V for universal line applications because the output voltage of a boost converter has to be larger than the input peak voltage. At high power levels, CCM boost converters have severe rectifier reverse recovery problems due to a high forward current and high output voltage. As a result, the active switch of the converter has huge turn-on current spikes. Such turn-on spikes are not only responsible for the high switching turn-on loss but also bring severe electromagnetic interference (EMI) noises. The efficiency of a boost converter could be significantly improved if the rectifier could be “softly” turned-off by controlling the rectifier current turn-off rate di/dt.

Fast recovery rectifiers could reduce reverse recovery charge with various effects if the boost rectifiers are “hard” switched, which means that the rectifier current turn-off rates di/dt are not controlled. Under “hard-switching” conditions, thermal management is difficult to deal with by using silicon rectifiers such as MUR860 and MURH860 at high power levels. GaAs rectifiers can significantly improve the efficiency and reduce the device stresses as well as the EMI noises. Although the GaAs rectifiers' performance is almost independent of junction temperature, the thermal problems still exist. Furthermore, GaAs rectifiers are expensive.

The state-of-the-art technology to alleviate the silicon rectifier reverse recovery problems is to “softly” turn-off the rectifier by controlling the di/dt of the rectifier current when the rectifier turns-off. All effective solutions could be divided as active approach and passive approach.

One technique is to shift the output rectifier current to a new parallel branch with an active switch. The boost switch turns on at zero-current condition. The new branch has a small inductor to control the rectifier current turn off rate di/dt. Because the added small inductor is essentially in parallel with the branch of boost switch, the boost switch has no extra voltage or current stress.

Another technique is to use an active clamp approaches by inserting a snubber inductor Ls into a loop passing rectifier reverse recovery current. The rectifier current turn-off rate could be controlled roughly as Vo/Ls. Meanwhile, an active switch and a small capacitor are also necessary to reset the snubber inductor. The advantages of the active approach are not only that the reverse recovery problem of the rectifier could be alleviated, but also the zero voltage switching (ZVS) of the main switch could be achieved.

However, conventional circuits used to accomplish the aforementioned techniques need an isolation gate drive. Overlapping of driver signals for the main switch and the auxiliary switch lead to a fatal circuit failure. Additionally, the leakage inductor of conventional circuits is possibly a concern at high power lever. The extra active switch and associated controller are not desirable from both cost and reliability points of view.

Another technique is a passive approach using passive components instead of an auxiliary active switch. Although the passive approach does not offer ZVS turn-on of the boost switch, this approach is just as effective as the active approach to alleviate the rectifier reverse recovery problem because the two approaches adopt the same principle to control the rectifier turn-off di/dt.

A major deficiency of the passive approach is not being able to provide the ZVS of the boost switch, but the high stresses of the current and/or voltage. On the one hand, higher-rated components are necessary to meet the increased stresses. The efficiency improvement is degraded by the increased conduction loss. On the other hand, the passive approach needs many passive components to realize the same function.

### SUMMARY OF THE INVENTION

The present invention to provides a simple solution to alleviate the rectifier reverse recovery problem. The proposed passive solution keeps the advantage of simplicity of the passive approaches, while the invented circuit does not suffer from voltage or current stress. By only adding one extra rectifier and one coupled winding to the boost inductor, the current through the original rectifier could be steered to a new branch. By careful design, the current through the original rectifier could be reduced to zero before the boost switch turns on. While the leakage inductor of the coupled boost inductor in the new branch is utilized to control the added rectifier current turn-off rate di/dt. The device voltage and current rating are the same as a conventional boost converter. Therefore, no higher-rated components are necessary. The invention is verified on a 500W, universal-line input boost converter for power factor correction. The proposed method is cost-effective to improve the efficiency by alleviating the rectifier reverse recovery problem.

According to the invention, there is provided a DC/DC converter for managing high voltage gain that includes an input side having a high tap and a low tap, an output side having a high tap and a low tap, a converter circuit interconnecting the input side and the output side, and a steering branch having at least one rectifier and one of at least one winding and a capacitor. The steering branch interconnects the input side with the output side. The converter circuit is preferably selected from the following types of conventional converter circuits: buck, boost, buck-boost, Cuk, Sepic, Zeta, half bridge boost for low-line input, half bridge boost for high-line input, and half bridge boost for universal-line input.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a circuit diagram of a DC/DC converter employing a boost converter circuit with a steering branch in accordance with the present invention;

FIG. 2 is a circuit diagram of an analysis model of the DC/DC converter employing the boost converter circuit shown in FIG. 1;

FIG. 3 is a graph showing key waveforms of the DC/DC converter employing the boost converter circuit shown in FIG. 1;

FIGS. 4A-E are equivalent circuit diagrams in one switching cycle for [T₀, T₁], [T₁, T₂], [T₂, T₃], [T₃, T₄], and [T₄, T₅], respectively, showing five topological stages of the converter shown in FIG. 1;

FIGS. 5A-F are examples of coupled inductor DC/DC converters employing the steering branch in accordance with the present invention; FIG. 6A is a circuit diagram of a half bridge boost converter for low-line input voltage employing the steering branch in accordance with the present invention;

FIG. 6B is a circuit diagram of a half-bridge converter for high-line input voltage employing the steering branch in accordance with the present invention;

FIG. 6C is a circuit diagram of a half-bridge converter for universal-line voltage input employing the steering branch in accordance with the present invention;

FIG. 7 is a graph showing the relationship of minimum required Ns/Np with the line variation for a 500W CCM boost converter at low-line input;

FIG. 8 is circuit diagram of a 500W CCM boost converter with circuit parameters and employing the steering branch in accordance with one embodiment of the present invention; FIG. 9A is a graph showing current and voltage waveforms of the rectifiers in the circuit shown in FIG. 8;

FIG. 9B is a detailed graph showing the waveform of the circled area in FIG. 9A;

FIG. 10A is a detailed graph showing current and voltage waveforms of a known DC-DC converter;

FIG. 10B is a graph showing the current and voltage waveforms of the rectifiers in the circuit shown in FIG. 8;

FIG. 11 is a graph showing the current and voltage waveforms of the rectifier Dₐ in the circuit shown in FIG. 8;

FIG. 12 is a graph showing the input current, switch current and voltage waveforms of the circuit shown in FIG. 8;

FIG. 13 is a graph showing a comparison of the efficiency under a known “hard-switching” condition and the efficiency of the circuit shown in FIG. 8;

FIG. 14 is a circuit diagram of a 500W CCM PFC boost DC/DC converter with universal-line input employing the steering branch in accordance with one embodiment of the present invention;

FIGS. 15A-B are graphs showing the input voltage and current waveforms in a line cycle at low line and high line, respectively, of the circuit shown in FIG. 14;

FIG. 16 is a graph showing the input current, switch current, and voltage waveforms in a switching cycle of the circuit shown in FIG. 14;

FIG. 17A is a graph showing the current through rectifiers Do and Dₐ of the circuit shown in FIG. 14;

FIG. 17B is a detailed graph of the circled area shown in FIG. 17A;

FIG. 18 is a graph showing a comparison of the efficiency under “hard-switching” (Nₛ=0) and “soft-switching” (Nₛ=1.08) of the circuit shown in FIG. 14;

FIG. 19 is a circuit diagram of a known clamp mode coupled inductor boost converter;

FIG. 20 is a circuit diagram of a clamp mode coupled inductor boost converter employing the steering branch in accordance with one embodiment of the present invention;

FIG. 21 is a graph showing key waveforms of the boost converter circuit shown in FIG. 20;

FIGS. 22A-F are equivalent circuit diagrams in one switching cycle for [T₀, T₁], [T₁, T₂], [T₂, T₃], [T₃, T₄], [T₄, T₅], and [T₅, T₀], respectively, showing six topological stages of the converter shown in FIG. 20;

FIG. 23 is a graph showing simulated key waveforms of the boost converter circuit shown in FIG. 20;

FIG. 24 is a graph showing switch voltage, capacitor voltage, and current through rectifier Dₒ of the circuit shown in FIG. 20;

FIG. 25 is a graph showing a comparison of the efficiency under different input voltages of the circuit shown in FIG. 20;

FIG. 26 is a circuit diagram of a coupled inductor boost converter converter with after shift clamp capacitor employing the steering branch in accordance with the present invention;

FIG. 27 is a circuit diagram of known coupled inductor buck-boost converter;

FIG. 28 is a circuit diagram of a clamp mode coupled inductor buck-boost converter employing the steering branch in accordance with the present invention;

FIG. 29 is a graph showing key waveforms of the buck-boost converter circuit shown in FIG. 28;

FIGS. 30A-F are equivalent circuit diagrams in one switching cycle for [T₀, T₁], [T₁, T₂], [T₂, T₃], [T₃, T₄], [T₄, T₅], and [T₅, T₀], respectively, showing six topological stages of the converter shown in FIG. 28;

FIG. 31 is a graph showing simulated key waveforms of the buck-boost converter circuit shown in FIG. 28;

FIG. 32 is a circuit diagram of a known coupled inductor Sepic converter;

FIG. 33 is a circuit diagram of a clamp mode coupled inductor Sepic converter employing the steering branch in accordance with the present invention; and

FIG. 34 is a graph showing simulated key waveforms of the Sepic converter shown in FIG. 33.

### DETAILED DESCRIPTION OF A PREFERRED EMBODIMENT OF THE INVENTION

In a most basic embodiment, the present invention is a DC/DC converter for managing high voltage gain that includes an input side having a high tap and a low tap, an output side having a high tap and a low tap, a converter circuit interconnecting the input side and the output side, and a steering branch having at least one rectifier and one of at least one winding and a capacitor. The steering branch interconnects the input side with the output side. The converter circuit is preferably selected from the following types of conventional converter circuits: buck, boost, buck-boost, Cuk, Sepic, Zeta, half bridge boost for low-line input, half bridge boost for high-line input, and half bridge boost for universal-line input.

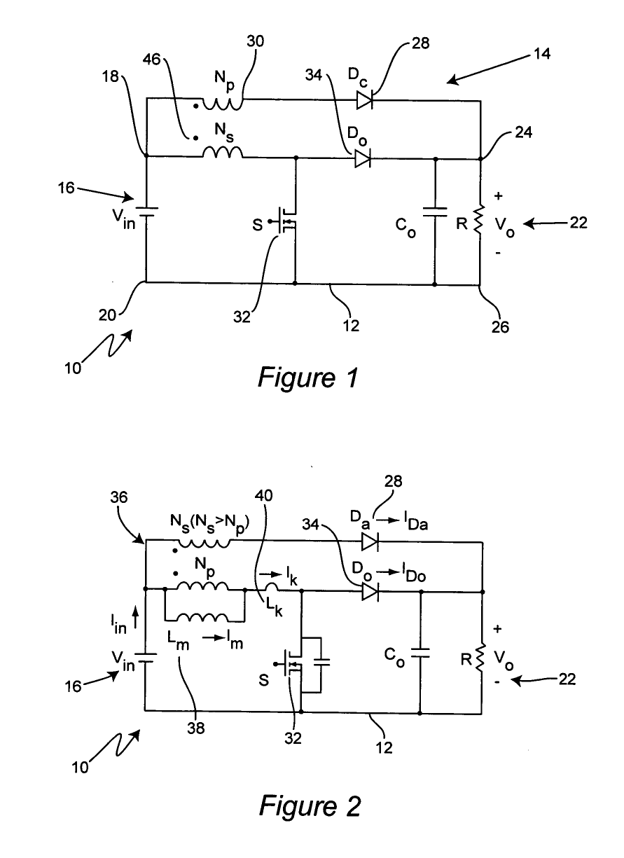

Referring now to the drawings, and more particularly to FIG. 1, there is shown a circuit diagram of a DC/DC converter, shown generally at 10, employing a boost converter circuit 12 with a steering branch, shown generally at 14, in accordance with the present invention. The DC/DC converter 10 includes an input side, shown generally at 16, having a high tap 18 and a low tap 20, an output side 22 having a high tap 24 and a low tap 26. The boost converter circuit 12 interconnects the input side 16 and the output side 22. The steering branch 14 has a rectifier 28 and a winding 30 and interconnects the input side 16 with the output side 22. The winding 30 is connected to the high tap 18 of the input side 16, and the rectifier 28 is connected to the high tap 24 of the output side 22.

The current of the boost branch is preferably steered to a new branch, or steering branch, which can control the current decrease rate of the boost branch when the rectifier turns-off. Before a boost switch 32 turns on, the current of an original boost rectifier 34 decreases to zero. The current in the new branch is controlled by a leakage inductor of a coupled inductor when the boost switch 32 turns-on.

FIG. 2 is a circuit diagram of an analysis model of the DC/DC converter 10 employing the boost converter circuit 12 shown in FIG. 1. To analyze the circuit operation, the coupled boost inductor is modeled as a combination of a magnetizing inductor Lₘ 38, an ideal transformer, shown generally at 36, and a leakage inductor Lₖ 40 as shown in FIG. 2.

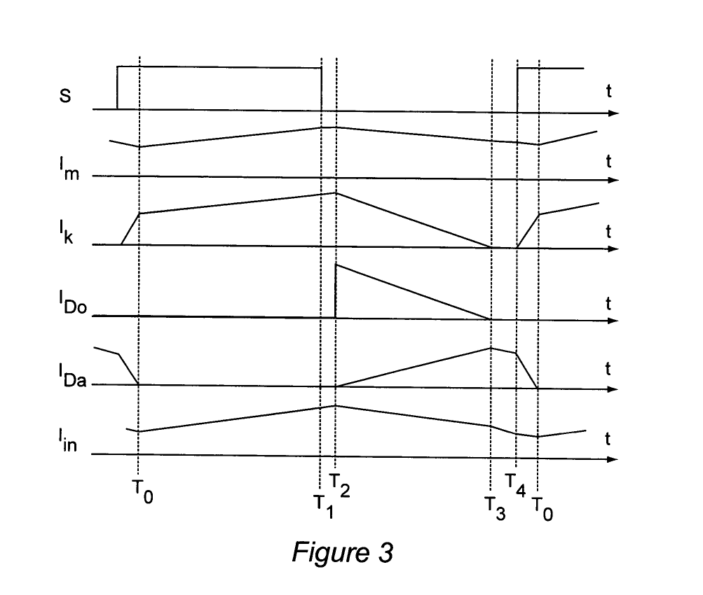

FIG. 3 is a graph showing key waveforms of the DC/DC converter 10 employing the boost converter circuit 12 shown in FIG. 1. Current waveforms are shown including the current across the switch S 32, Iₘ across the magnetizing inductor 38, Ik across the leakage inductor 40, I_{Do} across the output rectifier 34, I_{Da} across the added rectifier 28, and Iᵢₙ across the input side 16.

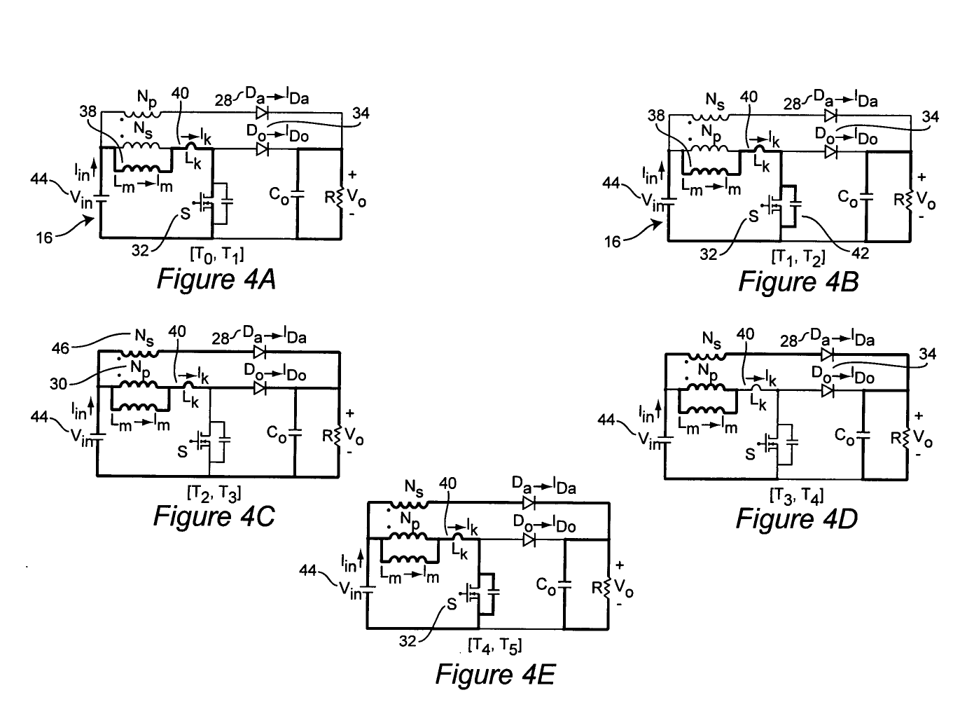

FIGS. 4A-E are equivalent circuit diagrams in one switching cycle for [T₀, T₁], [T₁, T₂], [T₂, T₃], [T₃, T₄], and [T₄, T₅], respectively, showing five topological stages of the converter shown in FIG. 1.
T₀-T₁: Switch S 32 is already on, and output rectifier Dₒ 34 is reversed biased. The magnetizing inductor 38 and the leakage inductor 40 are linearly charged by an input voltage source 44 applied at the input side 16.
T₁-T₂: Switch S 32 turns off at T₁. A parasitic capacitor 42 of the switch Cₛ 32 is charged by a magnetizing current in an approximate linear way.
T₂-T₃: At T₂, the parasitic capacitor Cₛ 42 is charged to an output voltage. The output rectifier Dₒ 34 and a clamp rectifier D_{c} 38 conduct at almost the same time. The reflected voltage from the winding Nₛ 46 to winding Nₚ 30 is (Vₒ−Vᵢₙ)/(Nₛ/Nₚ). The total voltage applied to the leakage inductor Lₖ 40 and the winding Nₚ 30 is Vₒ−Vᵢₙ. There is a negative voltage (Vₒ−Vᵢₙ)−(Vₒ−Vᵢₙ)/(Nₛ/Nₚ) to reset the leakage inductor 40.
T₃-T₄: If the leakage inductor 40 is provided enough reset voltage, the leakage inductor current is reduced to zero at T₃. All boost current goes to output filter through Dₐ 28. Output rectifier Dₒ 34 is naturally recovered.
T₄-T₅: At T₄ switch S 32 turns on again. Voltage Vᵢₙ+(Vₒ−Vᵢₙ)/(Nₛ/Nₚ) is applied to the leakage inductor 40. The turn-off rate di/dt of the rectifier Dₐ 34 is controlled by the leakage inductor 40. The reverse recovery problem of the rectifiers is alleviated.

To effectively alleviate the rectifier reverse recovery problem, the following two things are achieved in accordance with the present invention:
(a). The current through Dₒ 34 is reduced to zero before switch S 32 turn-on so that Dₐ 28 could be naturally recovered. The decrease rate of I_{da} is given by (1):

$$\frac{ⅆ {I}_{Do}}{ⅆ t} = \frac{{V}_{o} - [ {V}_{in} + \frac{{N}_{p}}{{N}_{s}} \cdot ( {V}_{o} - {V}_{in} ) ]}{{L}_{k}} \qquad ( 1 )$$

To eliminate the reverse recovery problem of Dₒ 34, IDO is decreased to zero before switch S 32 turns on. The following conditions are achieved (2) in accordance with the present invention:

$$\frac{ⅆ {I}_{Do}}{ⅆ t} \cdot ( 1 - d ) {T}_{s} > {I}_{Do} \qquad ( 2 )$$

The duty ratios of CCM boost converter PFC circuit vary with the line variation. The current is small when the duty ratio is large near the zero-crossing part of the input voltage 44. Although the switch S 32 has less turn-off time for the current to be shifted to the new branch, the current is also small. When the input voltage 44 is close to the peak area, the CCM boost converter has large rectifier forward current and small duty ratios. Therefore, more time is available for the current through Dₒ 34 to be reduced to zero. In other words no large Nₛ/Nₚ is necessary to reduce the current.
(b). To alleviate the rectifier reverse recovery problem of the added rectifier Dₐ 28, the current decrease rate of rectifier Dₐ 28 must be controlled when the switch turns on. The controlled rate is given by (3):

$$\frac{ⅆ {I}_{da}}{ⅆ t} = \frac{{V}_{in} + \frac{{N}_{p}}{{N}_{s}} \cdot ( {V}_{o} - {V}_{in} )}{{L}_{k}} \cdot \frac{{N}_{p}}{{N}_{s}} \qquad ( 3 )$$

Generally, this decrease rate is preferred to be controlled within about 100A/uS to effectively alleviate the rectifier reverse recovery problem. A larger Lₖ 40 could be more effective to control the dI_{Da}/dt. However, a larger Lₖ 40 requires a higher reset voltage to reduce its current to zero during a given period. A larger Nₛ/Nₚ is needed. There are two side effects for a large Nₛ/Nₚ.

First, a large Nₛ/Nₚ increases the voltage gain of the converter that is given by (4):

$$\frac{{V}_{o}}{{V}_{in}} = \frac{1 + ( k \cdot \frac{{N}_{s}}{{N}_{p}} - 1 ) \cdot ⅆ}{1 - ⅆ} \qquad ( 4 )$$

Increasing voltage gain is less desirable for front-end PFC boost converters because 400V or 450V voltage rating bulk capacitors are cost-effective solutions for the universal line applications. The term (K*Nₛ/Nₚ) should be as close to 1 as possible if the rectifier current decrease rate dI_{Dd}/dt is desired to be effectively controlled.

Second, there is a small slope change in the input current during the current steering process due to the Nₛ/Nₚ. After the current is steered to the new branch, the input current is larger than that at the switch turn-off instant due to the variation of the inductor turns. From both input filter and EMI points of view, the less the slope change, the more desirable. A small Nₛ/Nₚ is preferred.

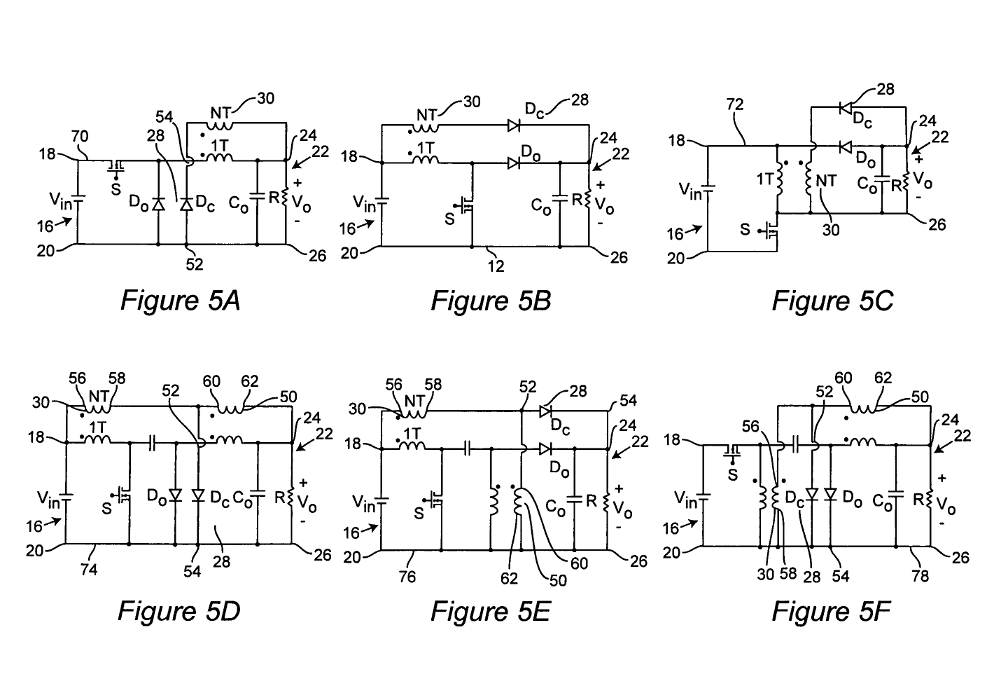

The steering branch concept as illustrated above could be extended to other topologies. FIGS. 5A-F are examples of coupled inductor DC/DC converters employing the steering branch in accordance with the present invention. FIGS. 5A-F show the application of the steering branch concept to five conventional DC/DC topologies, namely buck (FIG. 5A), boost (FIG. 5B), buck-boost (FIG. 5C), Cuk (FIG. 5D), Sepic (FIG. 5E), and Zeta (FIG. 5F) converters. The rectifier 28 has an input node 52 and an output node 54 and is connected in series at the output node 54 with the pair of windings 30, 50. Each of the pair of windings has an input node 56, 60 and an output node 58, 62. Two windings and a rectifier are used because the current through the original rectifier of the converter circuit is the summation of the current from the input inductor and the output inductor.

For the buck, boost, and buck-boost converters, the rectifier 28 is connected in series with the winding 30 in the steering branch. When the converter circuit is a buck converter 70, the rectifier 28 is connected to the low tap 20 of the input side 16 and the low tap 26 of the output side 22, and the winding 30 is connected to the high tap 24 of the output side 22, as shown in FIG. 5A. When the converter circuit is a buck-boost converter 72, the winding 30 is connected to the low tap 26 of the output side 22, and the rectifier 28 is connected to the high tap 24 of the output side, as shown in FIG. 5C.

For the Cuk, Sepic, and Zeta converters, the rectifier 28 is connected in series with a pair of windings 30, 50 in the steering branch. When the converter circuit is a Cuk converter 74, the output node 54 of the rectifier 28 is connected to both the low tap 20 of the input side 16 and the low tap 26 of the output side 22, the input node 56 of a first winding 30 is connected to the high tap 18 of the input side 16, and the output node 62 of a second winding 50 is connected to the high tap 24 of the output side 22, as shown in FIG. 5D. When the converter circuit is a Sepic converter 76, the output node 54 of the rectifier 28 is connected to the high tap 24 of the output side 22, the input node 56 of a first winding 30 is connected to the high tap 18 of the input side 16, and the output node 62 of a second winding 50 is connected to both the low tap 20 of the input side 16 and the low tap 26 of the output side 22, as shown in FIG. 5E. When the converter circuit is a Zeta converter 78, the output node 54 of the rectifier 28 is connected to both the low tap 20 of the input side 16 and the low tap 26 of the output side 22, the output node 58 of a first winding 30 is connected to both the low tap 20 of the input side 16 and the low tap 26 of the output side 22, and the output node 62 of a second winding 50 is connected to the high tap 24 of the output side 22, as shown in FIG. 5F.

A half-bridge boost converter employing the steering branch in accordance with the present invention is capable of achieving higher efficiency compared to a conventional half-bridge boost converter because there is only one switch in series in the current loop at any instant. The half-bridge boost converter is actually a combination of two boost converters sharing a common inductor. Each boost converter utilizes the body diode of another switch as the output rectifier. Therefore, the steering branch has an extra winding coupled with the inductor of the original half-bridge boost converter and two extra rectifiers.

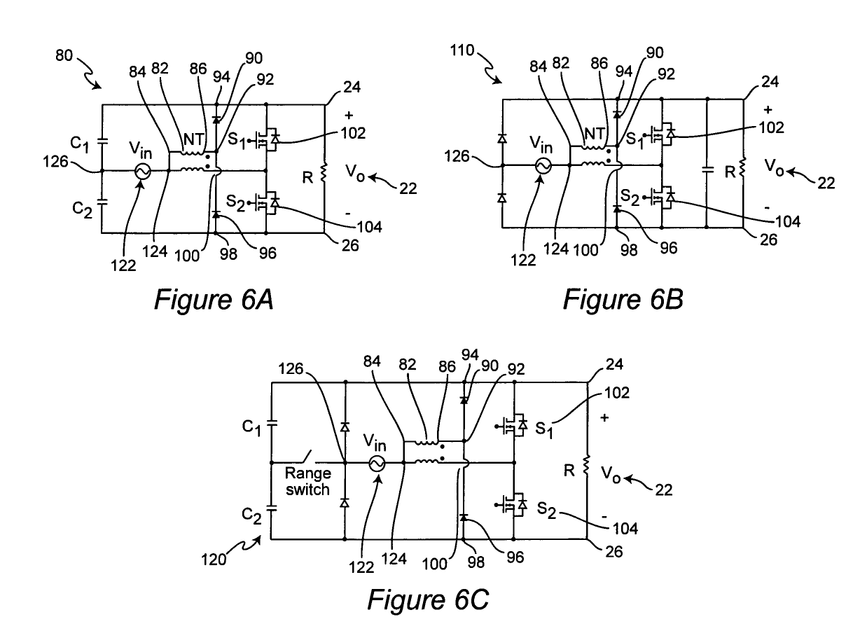

FIG. 6A is a circuit diagram of a half bridge boost converter for low-line input voltage, shown generally at 80, employing the steering branch in accordance with the present invention. FIG. 6A shows the application of the steering branch concept to the half-bridge boost converter 80 to alleviate rectifier reverse recovery problems. FIG. 6B is a circuit diagram of a half-bridge converter for high-line input voltage, shown generally 110, employing the steering branch in accordance with the present invention. FIG. 6B shows the application of the steering branch concept to the half-bridge boost converter 110 for high-line input voltage. FIG. 6C is a circuit diagram of a half-bridge converter for universal-line voltage input, shown generally at 120, employing the steering branch in accordance with the present invention. By combining the half-bridge boost converter for low line operation and the modified half-bridge for high line operation, the resulting converter circuit with a range switch shown in FIG. 6C for universal line application could be derived.

The steering branch preferably includes a winding 82 having an input node 84 and an output node 86. The winding 82 is connected in series at the output node 86 with a pair of rectifiers 90, 96. Each of the pair of rectifiers 90, 96 has an input node 92, 98 and an output node 94, 100. The output node 94 of a first rectifier 90 is connected to the high tap 24 of the output side 22, and the input node 98 of a second rectifier 96 is connected to the low tap 26 of the output side 22. By applying the proposed concept, the performance of half-bridge boost is dramatically improved. The reason is that body diodes 102, 104 of switches S₁ and S₂ are very slow diodes. It is difficult to push a conventional half-bridge boost converter to CCM operation while maintaining decent efficiency if the two switches are “hard” switched.

The preferred di/dt of rectifier turn-off rate is less than 100A/uS. From (3), it could be found the turn-off rate of the rectifier is roughly determined by Vₒ/Lₖ. The turn-off rate is controlled at 40A/uS in accordance with the present invention. The Lₖ is preferably selected as from about 9 to about 10 uH. For a boost converter, a 0.5 mH input inductor is more preferred. The couple coefficient k is about 0.98.

Due to line variations of an AC input, the duty ratio of the boost converters changes. The current through Dₒ needs to be reduced to zero during switch S's turn-off period, which is given by (5):

$${T}_{off} = ( 1 - d ) \cdot {T}_{s} = \frac{k \cdot ( {N}_{s} / {N}_{p} ) \cdot {V}_{in}}{{V}_{o} + ( k \cdot {N}_{s} / {N}_{p} - 1 ) \cdot {V}_{in}} \cdot {T}_{s} \qquad ( 5 )$$

Substituting equation (1) and (5) into equation (2), the minimum turns-ratio Nₛ/Nₚ to guarantee complete current shift could be expressed by (6):

$$\frac{{V}_{o} - {V}_{i} \cdot sin ( wt )}{\text{?} ( \frac{{V}_{o}}{{V}_{i} \cdot sin ( wt )} \cdot {L}_{k} \cdot {F}_{s} \cdot \frac{2 {P}_{o}}{{V}_{i}} sin ( wt ) )} - {V}_{i} \cdot si \\ \text{?} \text{indicates text missing or illegible when filed} \qquad ( 6 )$$

For a given output power, the turns-ratio is then a function of leakage inductor Lₖ. The Lₖ determines the preferred rectifier current turnoff rate di/dt, while the minimum Nₛ/Nₚ guarantees the current shifting so that the original rectifier could be naturally recombined.

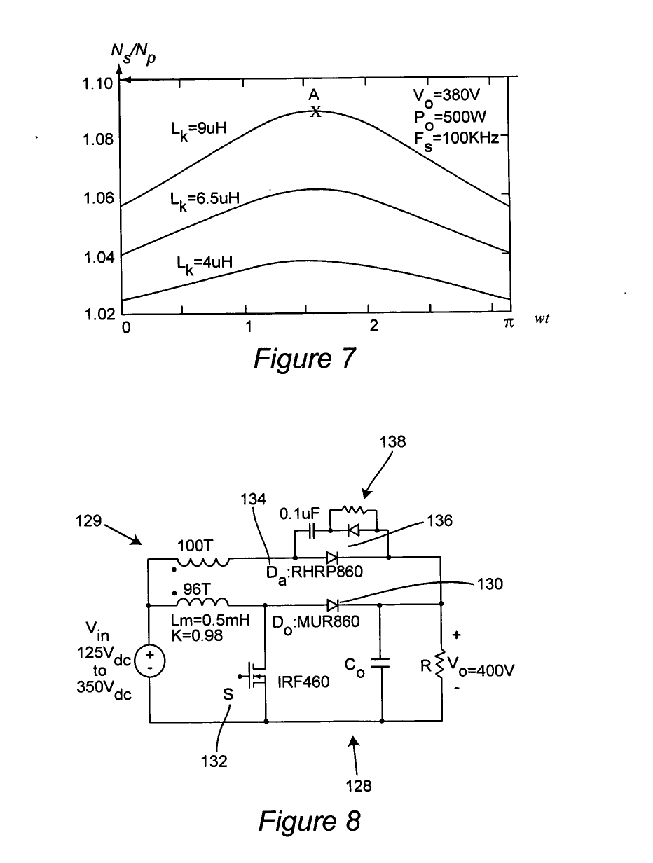

FIG. 7 is a graph showing the relationship of minimum required Nₛ/Nₚ with a line variation for a 500W CCM boost converter at low-line input. The minimum Nₛ/Nₚ required by this converter is about 1.09 to control the di/dt as about 45A/uS.

The following two converters are built in accordance with the present invention to test the performance:
1. A 500W continuous current mode (CCM) boost converter with 125-350 V DC input and 400V output.
2. A 500W continuous current mode (CCM) boost converter with 90-265V AC input and 375V DC output for power factor correction (PFC) applications.

FIG. 8 is circuit diagram of a 500W CCM boost converter, shown generally at 128, with circuit parameters and employing the steering branch, shown generally at 129, in accordance with one embodiment of the present invention. The circuit parameters are given in FIG. 8.

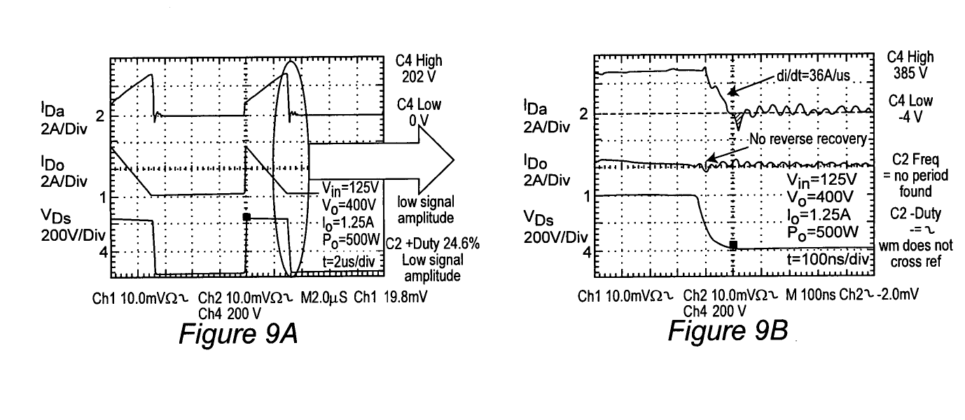

FIG. 9A is a graph showing current and voltage waveforms of the rectifiers in the circuit shown in FIG. 8. In particular, the current through the added rectifier 28, I_{Da}, and the current through the output rectifier 130, I_{Do}, are shown. FIG. 9B is a detailed graph showing the waveform of the circled area in FIG. 9A. FIGS. 9A and B show that the current I_{Do} through rectifier Dₒ 130 decreases to zero before switch S 132 turns on, while the current decrease rate di/dt through Dₐ 134 is controlled by the leakage inductor 40. The decrease rate di/dt is about Vₒ/Lₖ=40 A/uS.

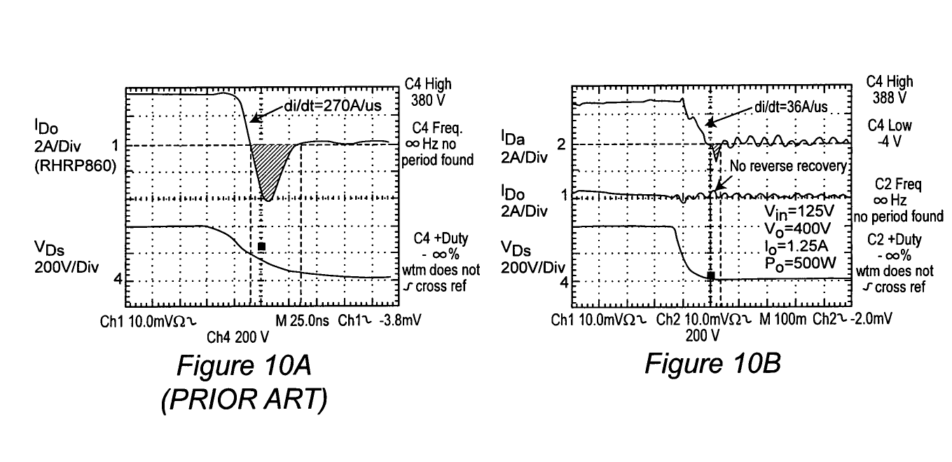

FIG. 10A is a detailed graph showing current and voltage waveforms of a known DC/DC boost converter. In particular, the current through an output rectifier, I_{Do}, of the known boost converter is shown. FIG. 10B is a graph showing the current and voltage waveforms of the rectifiers 130, 134 in the circuit 128 shown in FIG. 8. In particular, the currents through the added rectifier 28, I_{Da}, and the current through the output rectifier 130, I_{Do}, are shown. FIG. 10a shows the output rectifier 130 has severe reverse recovery problem without any turn-on snubber, which is termed “hard switching” condition. FIG. 10B illustrates that the invented steering branch can significantly alleviate the rectifier reverse recovery problem. By controlling the current turn-off rate, not only the reverse recovery current is reduced, but also the moment of the reverse recovery is delayed. The switch voltage is already decreased to zero when the reverse recovery current appears. Therefore, the switching loss is dramatically reduced. Due to the resonance of the leakage inductor and the parasitic capacitor 136 of the rectifier Dₐ 134, a snubber circuit, shown generally at 138, is used to reduce the peak voltage of the rectifier Dₐ 134.

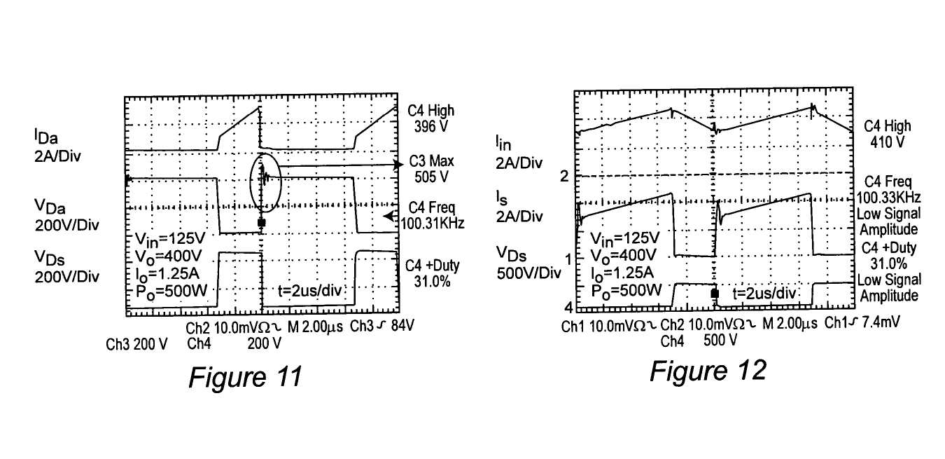

FIG. 11 is a graph showing the current and voltage waveforms of the rectifier Dₐ 134 in the circuit shown in FIG. 8. FIG. 11 shows no voltage stress is applied to the rectifier Dₐ 134. Due to the help of the snubber circuit 138, the maximum voltage of rectifier Dₐ is about 505V. In this case, a 600V rectifier could be safely used.

FIG. 12 is a graph showing the input current, switch current and voltage waveforms of the circuit 128 shown in FIG. 8. As best shown in FIG. 12, the switch turn-on current spike is almost eliminated due to the alleviated reverse recovery problem of the output rectifier 130. The voltage applied to the switch S 132 is the output voltage.

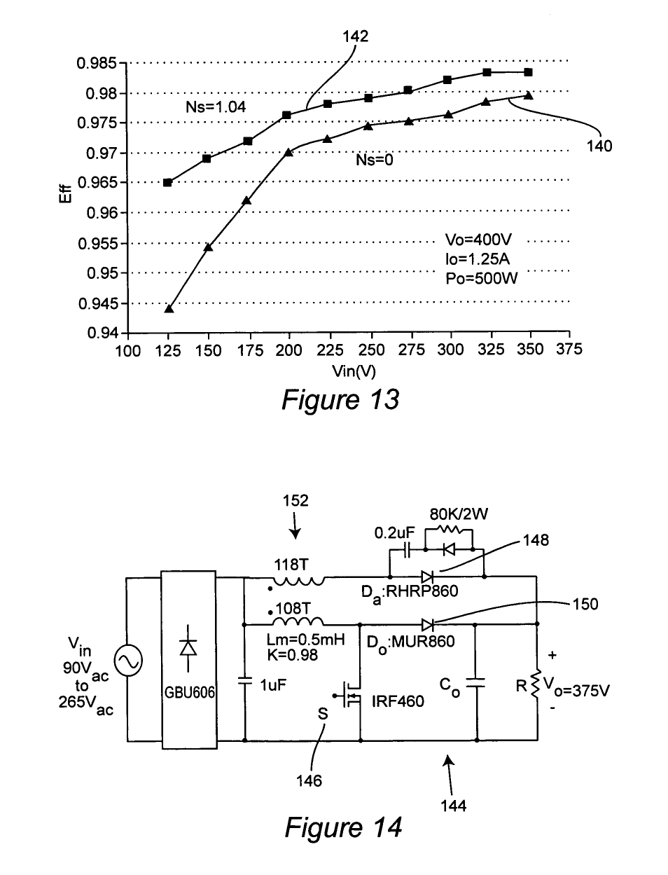

FIG. 13 is a graph showing a comparison of the efficiency under a known “hard-switching” condition 140 and the efficiency of the circuit shown in FIG. 8142. The efficiency of the known “hard-switching” condition is shown using triangular data points, and the efficiency of the circuit 128 shown in FIG. 8 is shown using square data points. A 2% efficiency improvement is achieved by the circuit 128 shown in FIG. 8 over the known “hard-switching” condition.

FIG. 14 is a circuit diagram of a 500W CCM PFC boost DC/DC converter, shown generally at 144, with universal-line input and employing the steering branch, shown generally at 152, in accordance with one embodiment of the present invention. The circuit parameters are given in FIG. 14.

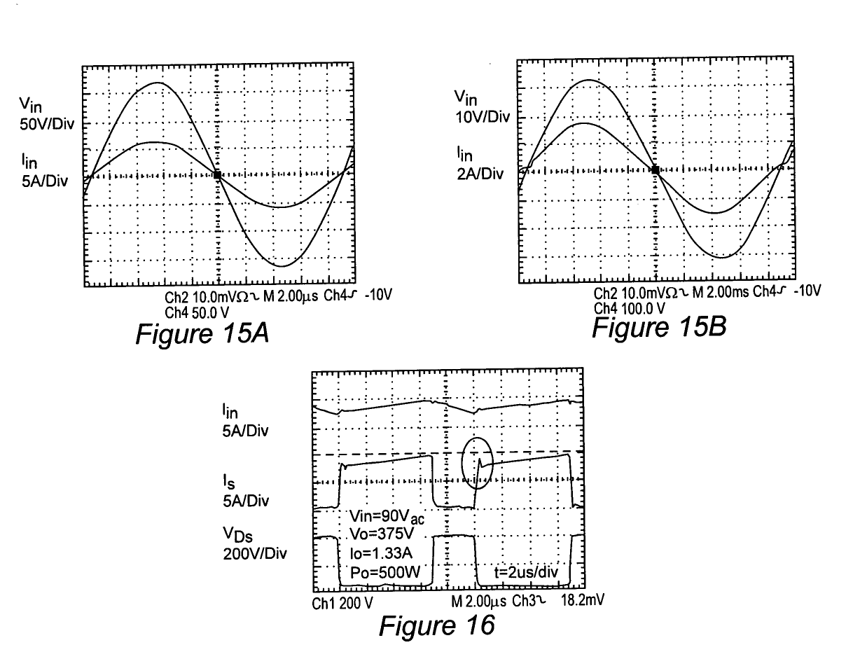

FIGS. 15A-B are graphs showing the input voltage and current waveforms in a line cycle at low line and high line, respectively, of the circuit 144 shown in FIG. 14.

FIG. 16 is a graph showing the input current, switch current, and voltage waveforms in a switching cycle of the circuit 144 shown in FIG.

14. As can be seen, the switch turn-on current spike is eliminated due to the alleviated reverse recovery problems of the output rectifier Dₒ 150.

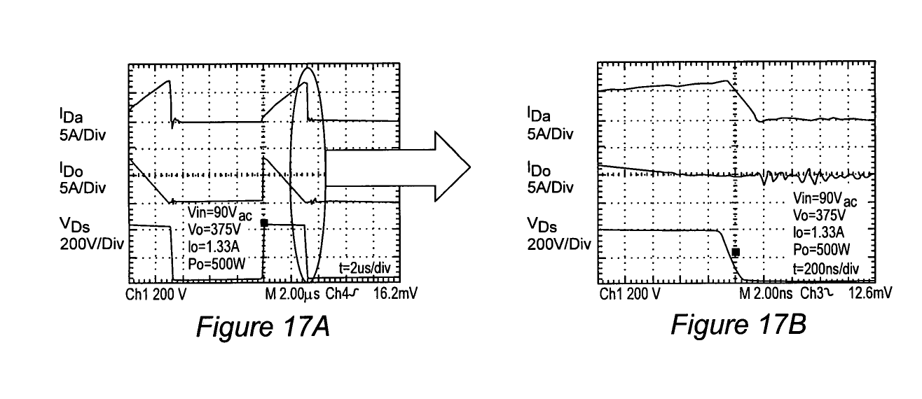

FIG. 17A is a graph showing the current through rectifiers Dₒ and Dₐ of the circuit 144 shown in FIG. 14. FIG. 17A shows the current through output rectifier Dₒ 150 is already zero before the switch S 146 turns on again. So Dₒ 150 is naturally recovered and has no reverse recovery problem. The current decreases rate through the added rectifier Dₐ 148 is controlled. Therefore, the reverse recovery problem of Dₐ 148 is alleviated in accordance with the present invention. FIG. 17B is a detailed graph of the circled area shown in FIG. 17A. FIG. 17B shows the details of the circled area in FIG. 17A with an enlarged time base.

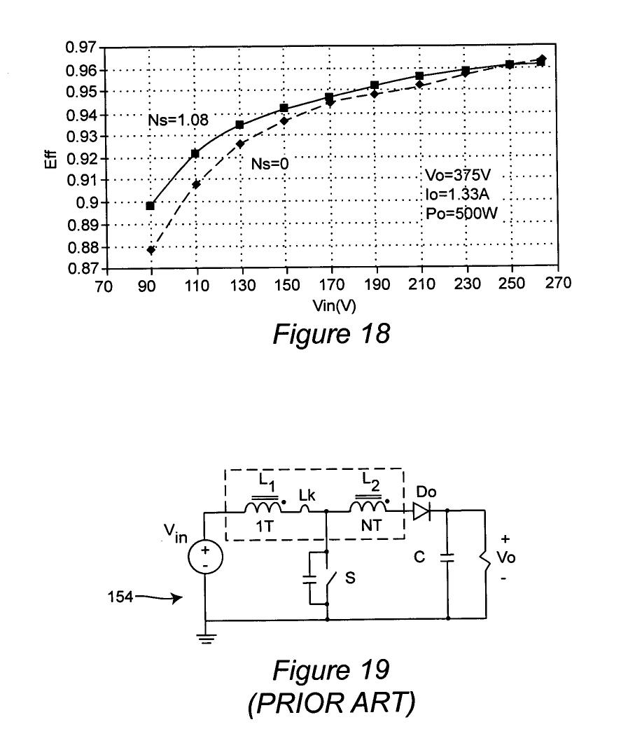

FIG. 18 is a graph showing a comparison of the efficiency under “hard-switching” (Nₛ=0) and “soft-switching” (Nₛ=1.08) of the circuit shown in FIG. 14. FIG. 18 compares the efficiency under “hard-switching” (Nₛ=0) and “soft-switching” (Nₛ=1.08). The efficiency under “hard-switching” is represented in dashed line. The efficiency under “soft-switching” is represented in solid line. The efficiency under “soft-switching” has a 2% improvement at low line over “hard-switching”.

For buck, boost, and buck-boost DC/DC converter topologies, the present invention alleviates rectifier reverse recovery problem effectively with only one extra winding of the boost inductor and one extra rectifier. Compared with the active and other passive solutions, the present invention is cost-effective without extra voltage or current stress and can be easily applied to various topologies with simple structures.

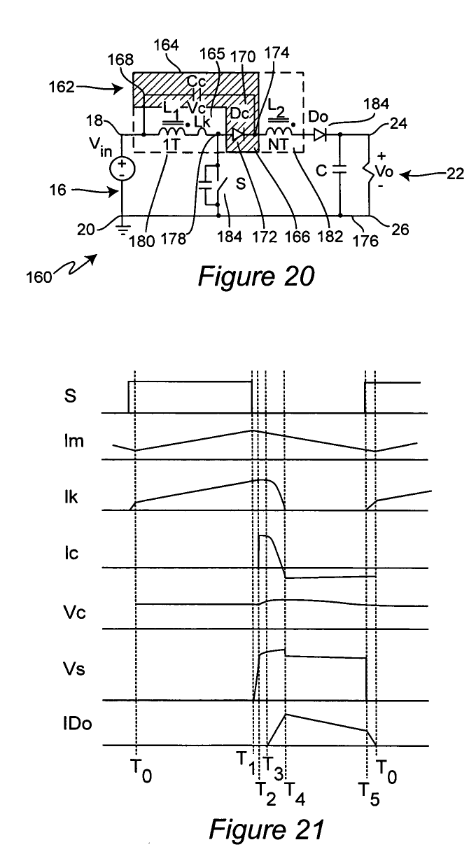

FIG. 19 is a circuit diagram of a known coupled inductor boost converter, shown generally at 154. FIG. 20 is a circuit diagram of a clamp mode coupled inductor boost converter, shown generally at 160, employing the steering branch, shown generally at 162, in accordance with one embodiment of the present invention. The steering branch 162 includes a capacitor 164 connected to a rectifier 166. The capacitor 164 has an input node 168 and an output node 170, and the rectifier 166 has an input node 172 and an output node 174. In this embodiment where the DC/DC converter circuit is a boost converter 176, the boost converter 176 has a center node 178 joining a first inductor 180, a second inductor 182, and a switch S 184. The first inductor 180 is connected to the high tap 18 of the input side 16, and the second inductor 182 is connected to an output rectifier 184. The output rectifier 184 is connected to the high tap 24 of the output side 22. The rectifier 166 of the steering branch 162 interconnects the center node 178 with the second inductor 182. The capacitor 164 of the steering branch 162 interconnects the high tap 18 of the input side 16 with both the second inductor 182 and the rectifier 166 of the steering branch 162.

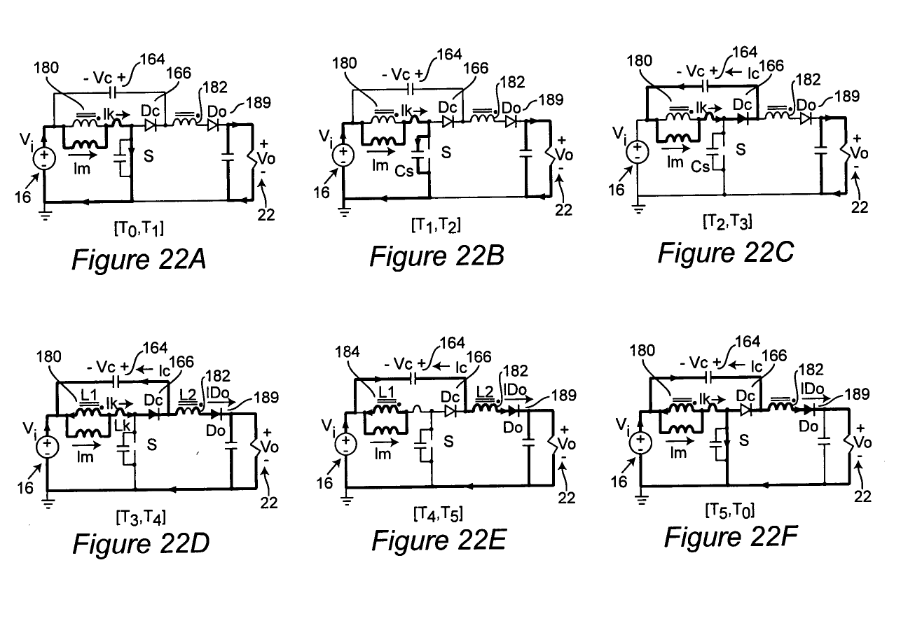

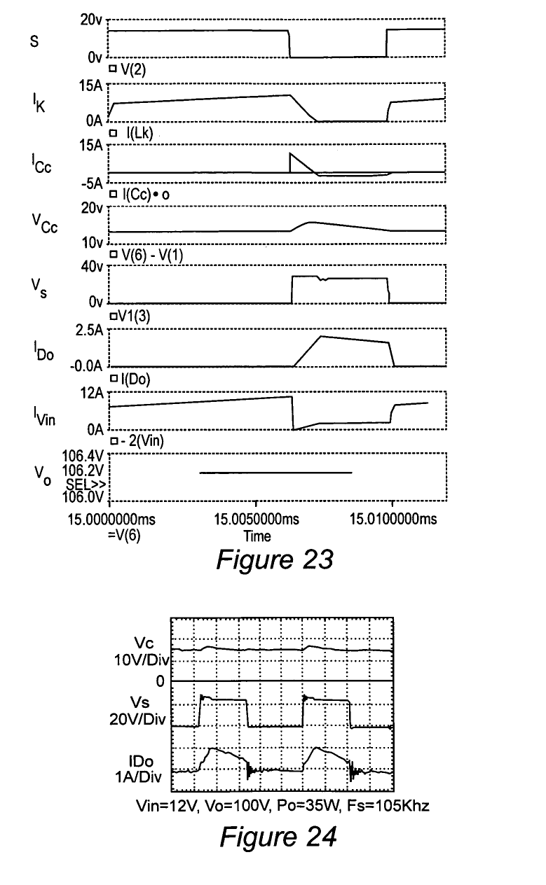

FIG. 21 is a graph showing key waveforms of the boost converter circuit 160 shown in FIG. 20. In particular, FIG. 21 shows the current across the switch S 184, the current across the magnetizing inductor 180, Iₘ, the current across the leakage inductor 165, Iₖ, the current across the added capacitor 164, I_{c}, the voltage across the added capacitor 164, V_{c}, the voltage across the switch 184, Vₛ, and the current across the output rectifier 184, I_{Do}. FIGS. 22A-F are equivalent circuit diagrams in one switching cycle for [T₀, T₁], [T₁, T₂], [T₂, T₃], [T₃, T₄], [T₄, T₅], and [T₅, T₀], respectively, showing six topological stages of the converter 160 shown in FIG. 20. FIG. 23 is a graph showing simulated key waveforms of the boost converter circuit 160 shown in FIG. 20. The simulated key waveforms appear similar to the corresponding key waveforms shown in FIG. 21.

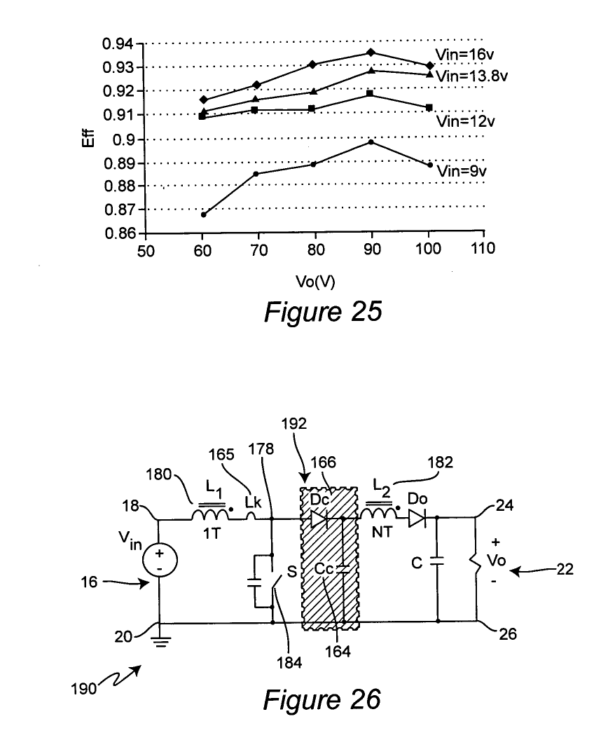

FIG. 24 is a graph showing switch voltage, capacitor voltage, and current through rectifier Dₒ 184 of the circuit 160 shown in FIG. 20. FIG. 25 is a graph showing a comparison of the efficiency under different input voltages, Vᵢₙ, of the circuit 160 shown in FIG. 20.

FIG. 26 is a circuit diagram of a coupled inductor boost converter converter with after shift clamp capacitor, shown generally at 190, employing the steering branch, shown generally at 192, in accordance with the present invention. The rectifier 166 of the steering branch 192 interconnects the center node 178 with the second inductor 182. The capacitor 164 of the steering branch 192 interconnects both the low tap 20 of the input side 16 with the low tap 26 of the output side 22 with both the rectifier 166 of the steering branch 192 and the second inductor 182.

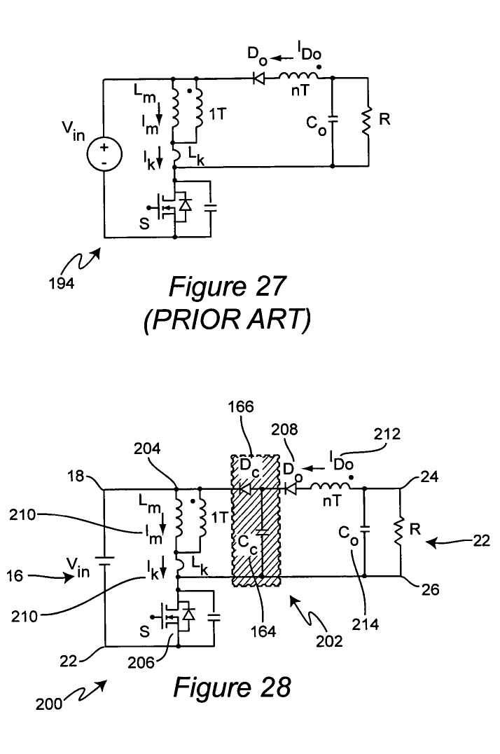

FIG. 27 is a circuit diagram of known coupled inductor buck-boost converter, shown generally at 194. FIG. 28 is a circuit diagram of a clamp mode coupled inductor buck-boost converter, shown generally at 200, employing the steering branch, shown generally at 202, in accordance with the present invention. The buck-boost converter 200 has a node 204 that connected to an output rectifier 208. The node 204 joins a magnetizing inductor 210 and the high tap 18 of the input side 16. The rectifier 166 of the steering branch 202 interconnects the first node 204 with the output rectifier 208. The capacitor 164 of the steering branch 202 interconnects the low tap 26 of the output side 22 with both the rectifier 166 of the steering branch 202 and the output rectifier 208.

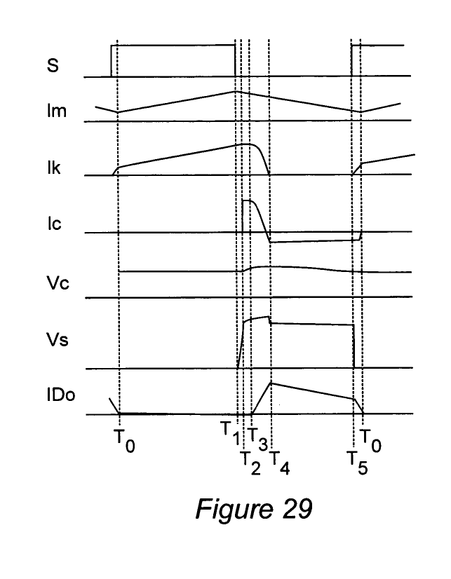

FIG. 29 is a graph showing key waveforms of the buck-boost converter circuit shown in FIG. 28. In particular, FIG. 29 shows the current across the switch S 206, the current across the magnetizing inductor 210, Iₘ, the current across the leakage inductor 210, Iₖ, the current across the added capacitor 164, I_{c}, the voltage across the added capacitor 164, V_{c}, the voltage across the switch 206, Vₛ, and the current across the output rectifier 208, I_{Do}.

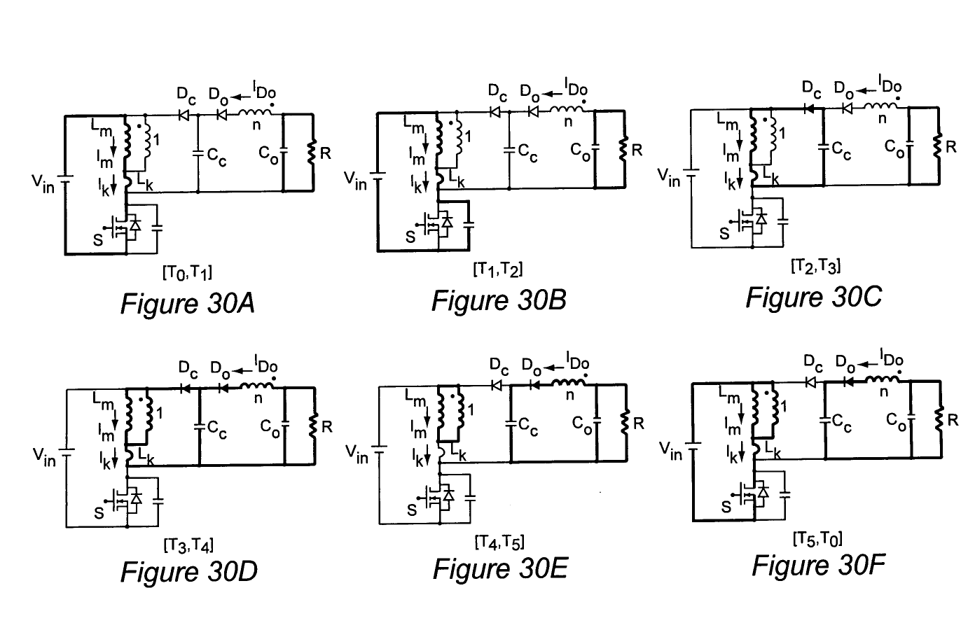

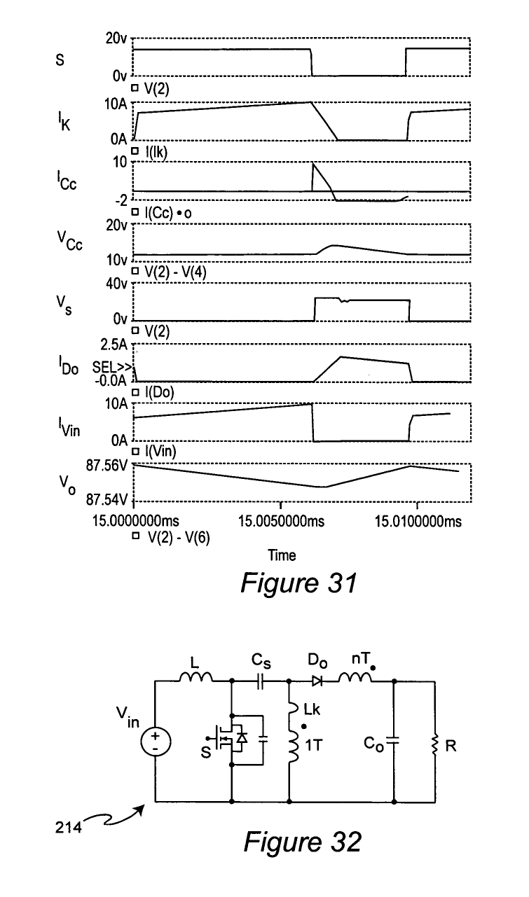

FIGS. 30A-F are equivalent circuit diagrams in one switching cycle for [T₀, T₁], [T₁, T₂], [T₂, T₃], [T₃, T₄], [T₄, T₅], and [T₅, T₀], respectively, showing six topological stages of the converter shown in FIG. 28. FIG. 31 is a graph showing simulated key waveforms of the buck-boost converter circuit shown in FIG. 28. The simulated key waveforms appear similar to the corresponding key waveforms shown in FIG. 29.

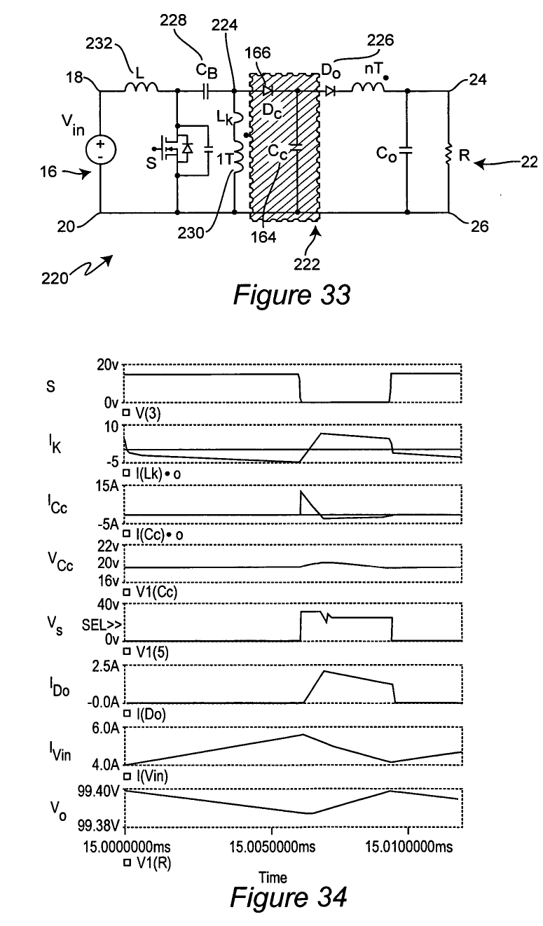

FIG. 32 is a circuit diagram of a known coupled inductor Sepic converter, shown generally at 214. FIG. 33 is a circuit diagram of a clamp mode coupled inductor Sepic converter, shown generally at 220, employing the steering branch, shown generally at 222, in accordance with the present invention. The Sepic converter 220 has a center node 224 connected to an output rectifier 226. The center node 224 joins a capacitor 228 with a first inductor 230. The first inductor 230 is connected to both the low tap 22 of the input side 16 and the low tap 26 of the output side 22. The capacitor 228 is connected to a second inductor 232, and the second inductor 232 is connected to the high tap 18 of the input side 16. The rectifier 166 of the steering branch 222 interconnects the center node 224 with the output rectifier 226. The capacitor 164 of the steering branch 222 interconnects both the low tap 22 of the input side 16 and the low tap 26 of the output side 22 with both the output rectifier 226 and the rectifier 166 of the steering branch 222.

FIG. 34 is a graph showing simulated key waveforms of the Sepic converter shown in FIG. 33.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A DC/DC converter for managing high voltage gain, the converter comprising:
an input side having a high tap and a low tap;
an output side having a high tap and a low tap;
a converter circuit interconnecting said input side and said output side; and
a steering branch having at least one rectifier and one of at least one winding and a capacitor, said steering branch interconnecting said input side with said output side.

2. A DC/DC converter according to claim 1, wherein said converter circuit is selected from buck, boost, buck-boost, Cuk, Sepic, Zeta, half bridge boost for low-line input, half bridge boost for high-line input, and half bridge boost for universal-line input.

3. A DC/DC converter according to claim 1, wherein said steering branch includes a rectifier in series with a winding.

4. A DC/DC converter according to claim 3, wherein said converter circuit is a buck converter; and wherein said rectifier is connected to said low tap of said input side and said low tap of said output side, and said winding is connected to said high tap of said output side.

5. A DC/DC converter according to claim 3, wherein said converter circuit is a boost converter; and wherein said winding is connected to said high tap of said input side, and said rectifier is connected to said high tap of said output side.

6. A DC/DC converter according to claim 3, wherein said converter circuit is a buck-boost circuit; and wherein said winding is connected to said low tap of said output side, and said rectifier is connected to said high tap of said output side.

7. A DC/DC converter according to claim 1, wherein said steering branch includes a rectifier having an input node and an output node, said rectifier connected in series at the output node of said rectifier with a pair of windings, and each of said pair of windings having an input node and an output node.

8. A DC/DC converter according to claim 7, wherein said converter circuit is a Cuk converter; and wherein said output node of said rectifier is connected to both said low tap of said input side and said low tap of said output side, said input node of a first winding of said pair of windings is connected to said high tap of said input side, and said output node of a second winding of said pair of windings is connected to said high tap of said output side.

9. A DC/DC converter according to claim 7, wherein said converter circuit is a Sepic converter; and wherein said output node of said rectifier is connected to said high tap of said output side, said input node of a first winding of said pair of windings is connected to said high tap of said input side, and said output node of a second winding of said pair of windings is connected to both said low tap of said input side and said low tap of said output side.

10. A DC/DC converter according to claim 1, wherein said converter circuit is a Zeta converter; and wherein said output node of said rectifier is connected to both said low tap of said input side and said low tap of said output side, said output node of a first winding of said pair of windings is connected to both said low tap of said input side and said low tap of said output side, and said output node of a second winding of said pair of windings is connected to said high tap of said output side.

11. A DC/DC converter according to claim 1, wherein said steering branch includes a winding having an input node and an output node, said winding connected in series at said output node with a pair of rectifiers, each of said pair of rectifiers having an input node and an output node.

12. A DC/DC converter according to claim 11, wherein said output node of a first rectifier of said pair of rectifiers is connected to said high tap of said output side, and said input node of a second rectifier of said pair of rectifiers is connected to said low tap of said output side.

13. A DC/DC converter according to claim 12, wherein said converter circuit is selected from a half bridge boost circuit for low-line input, a half bridge boost circuit for high-line input, and a half bridge boost circuit for universal-line input.

14. A DC/DC converter according to claim 1, wherein said steering branch includes a capacitor connected to a rectifier, said capacitor having an input node and an output node, and said rectifier having an input node and an output node.

15. A DC/DC converter according to claim 14, wherein said converter circuit is a boost converter having center node joining a first inductor a second inductor and a switch, said first inductor connected to said high tap of said input side, and said second inductor connected to an output rectifier, said output rectifier connected to said high tap of said output side.

16. A DC/DC converter according to claim 14, wherein said rectifier of said steering branch interconnects said center node with said second inductor, and said capacitor of said steering branch interconnects said high tap of said input side with both said second inductor and said rectifier of said steering branch.

17. A DC/DC converter according to claim 14, wherein said rectifier of said steering branch interconnects said center node with said second inductor, and said capacitor of said steering branch interconnects both of said low tap of said input side with said low tap of said output side with both of said rectifier of said steering branch and said second inductor.

18. A DC/DC converter according to claim 14, wherein said converter circuit is a buck-boost converter having a node connected to an output rectifier, said first node joining a magnetizing inductor and said high tap of said input side; and wherein said rectifier of said steering branch interconnects said first node with said output rectifier, said capacitor of said steering branch interconnects said low tap of said output side with both of said rectifier of said steering branch and said output rectifier.

19. A DC/DC converter according to claim 14, wherein said converter circuit is a Sepic converter having a center node connected to an output rectifier, said center node joining a capacitor with a first inductor, said first inductor connected to both of said low tap of said input side and said low tap of said output side, said capacitor connected to a second inductor, said second inductor connected to said high tap of said input side; and wherein said rectifier of said steering branch interconnects said center node with said output rectifier, and said capacitor of said steering branch interconnects both of said low tap of said input side and said low tap of said output side with both of said output rectifier and said rectifier of said steering branch.
